(19) United States
(12) Patent Application Publication
(10) Pub. No.: US 2025/0131246 A1
(43) Pub. Date: Apr. 24, 2025

(54) SYSTEMS AND METHODS FOR AN ATTENTION-BASED NEURAL NETWORK ARCHITECTURE

(71) Applicant: Salesforce, Inc., San Francisco, CA (US)

(72) Inventors: Devansh Arpit, Pacifica, CA (US); Huan Wang, Palo Alto, CA (US); Caiming Xiong, Menlo Park, CA (US)

(21) Appl. No.: 18/492,408

(22) Filed: Oct. 23, 2023

(51) Int. Cl. G06N 3/0455; G06N 3/084

(52) U.S. Cl. CPC G06N 3/0455; G06N 3/084

(57) ABSTRACT

Embodiments provide an attention mechanism that computes attention weights for an input sequence by employing a set of multi-head learnable vectors (referred to as “binder vectors”) to attend to the input sequence.

### TECHNICAL FIELD

The embodiments relate generally to machine learning systems for neural networks and deep learning models, and more specifically to an attention-based neural network architecture.

### BACKGROUND

Machine learning systems have been widely used in natural language processing (NLP) tasks. For example, some existing NLP models employ a Transformer architecture based on a self-attention mechanism that computes attention weights, pair-wisely between all positions of an input sequence. Such computed weights an importance or relevance of different tokens and/or positions of the input sequence. However, such self-attention mechanism often requires quadratic time complexity of the input sequence length, and thus renders the existing NLP models computationally expensive in both time and resource

### BRIEF DESCRIPTION OF THE DRAWINGS

FIG. 1 is a simplified diagram illustrating an example structure of a neural network based NLP model, according to some embodiments described herein.

FIG. 2 is a simplified diagram illustrating an example structure of an encoder layer and/or a decoder layer of the NLP model shown in FIG. 1, according to some embodiments.

FIG. 3A is an example structure of at least one attention head of the binder multi-head attention module in FIG. 2, according to one or more embodiments described herein.

FIG. 3B is an example diagram illustrating an operation surrounding the addition and normalization layer, the Feed Forward layer and another addition and normalization layer in FIG. 2, according to one or more embodiments described herein.

FIG. 4 is a simplified diagram illustrating a computing device implementing the binder multi-head attention described in FIGS. 1-3B, according to one embodiment described herein.

FIG. 5 is a simplified diagram illustrating the neural network structure implementing the neural network module described in FIG. 4, according to some embodiments.

FIG. 6 is a simplified block diagram of a networked system suitable for implementing the binder attention based NLP framework described in FIGS. 1-5 and other embodiments described herein.

FIG. 7 is an example logic flow diagram illustrating a method of performing binder attention based natural language modeling based on the framework shown in FIGS. 1-6, according to some embodiments described herein.

FIGS. 8-11 represent exemplary test results using embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Transformer” refers to a deep learning model architecture for natural language processing (NLP) tasks and other sequence-to-sequence tasks in machine learning and artificial intelligence. Specifically, the Transformer architecture adopts a self-attention mechanism that weighs the importance of different parts of an input sequence, which in turn captures relationships and dependencies between elements in an input sequence.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

Existing LLM models employ a Transformer architecture based on a self-attention mechanism that computes attention weights, pair-wisely between all positions of an input sequence. Such computed weights an importance or relevance of different tokens and/or positions of the input sequence. However, such self-attention mechanism often requires quadratic time complexity of the input sequence length, e.g., [symbol] (S²) time complexity, where S is the sequence length. When input sequences have a significant length for certain tasks (e.g., summarization, etc.), traditional Transformer architecture can be computationally expensive in both time and resource.

In view of computational inefficiency of existing Transformer based models, embodiments provide an attention mechanism that computes attention weights for an input sequence by employing a set of multi-head learnable vectors (referred to as “binder vectors”) to attend to the input sequence. Specifically, multi-head attention is used to compute the attention weights. At each attention head, an attention weight of a token is computed between the same set of learnable vector and a respective key vector. That is, the same set of learnable vector is used to compute the attention parameters for all tokens at the same head. Each head may have the output of a set of attention parameters, each corresponding to a respective token from the input sequence. The sets of attention weights from multiple heads are then concatenated to form a global context vector, which is further concatenated and transformed to a non-linear form for each token by a feed forward layer. The feed forward layer mixes the input sequence and the concatenated global context vector to generate the attention weights. In this way, the binder network layer using the binder-based attention mechanism generates a layer output with a linear time complexity of the input sequence length, which greatly improves computational efficiency in NLP.

In this way, the learnable binder vectors may replace the input dependent query vectors in traditional transformer attention layers, and bind the information across the sequence into one global context vector. Specifically, the multi-head attention mechanism largely reduce the computational complexity of producing attention weights, e.g., [symbol] (Sd²) complexity attention is achieved based architecture for sequence-to-sequence modeling, where S is the length of the input sequence and d is the dimension of the feature vector of the input sequence. Therefore, even when the length of input sequence increases (e.g., to process a large input document, and/or the like), computational complexity of the multi-head attention at most grow linearly with the input sequence length, instead of quadratically as in self-attention of traditional Transformer architectures. With improved computational complexities, NLP models employing the multi-head attention mechanism may process NLP tasks more efficiently. For example, faster processing and less latency may be experienced in an online AI agent employing an NLP model. Neural network technology in AI agents is thus improved.

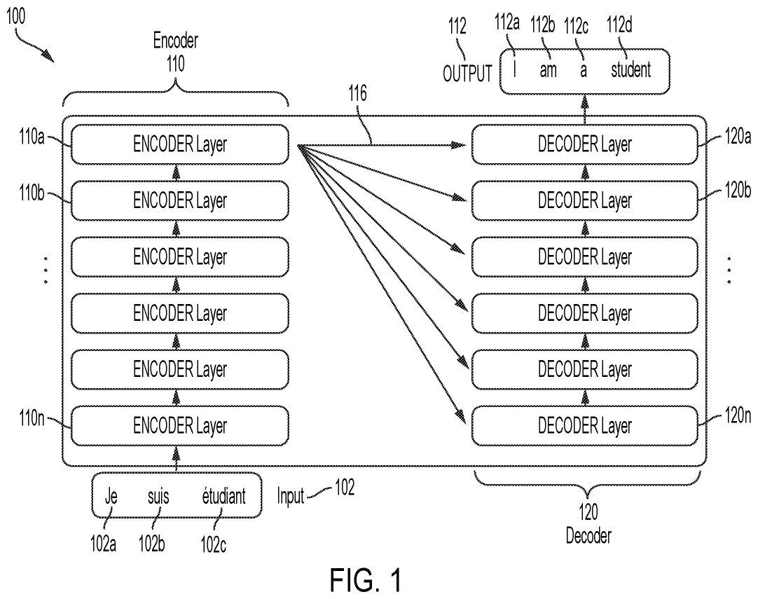

FIG. 1 is a simplified diagram illustrating an example structure of a neural network based NLP model 100 according to some embodiments. The NLP model 100 may be configured to perform a number of NLP tasks, such as but not limited to question answering, summarization, document retrieval, machine translation, and/or the like. For example, as shown in FIG. 1, NLP model 100 may receive an input sequence 102 comprising a plurality of tokens 102a-c, e.g., “Je suis etudiant” in French, and then generate an output sequence 112 comprising a plurality of tokens 112a-c, e.g., “I am a student” which is an English translation of the input sequence 102.

In one embodiment, the NLP model 100 may comprise an encoder 110 and a decoder 120. The encoder 110 may comprise a plurality of encoder layers 110a-n. Each encoder layer 110a-n may receive an encoder layer input from the previous encoder layer, and transform the encoder layer input to a current encoder layer output. The output from the last encoder layer may be encoded representations 116 of the input sequence 102, which are fed to decoder layers 120a-n of the decoder 120. Each decoder layer 120a-n may receive a decoder layer input from the previous decoder layer, and transform the decoder layer input and encoded representations to a current encoder layer output. Specifically, the last layer of decoder 120 may sequentially generate a predicted probability distribution of the next token, conditioned on the encoded representations 116 and previously decoded tokens.

In one embodiment, the decoder 120 may work in an autoregressive manner. For example, when translating input sentence 102 to output sentence 112, the autoregressive decoder 120 generates each word 112a-d in the output sentence 112 one at a time while looking at the preceding words in the translated sentence.

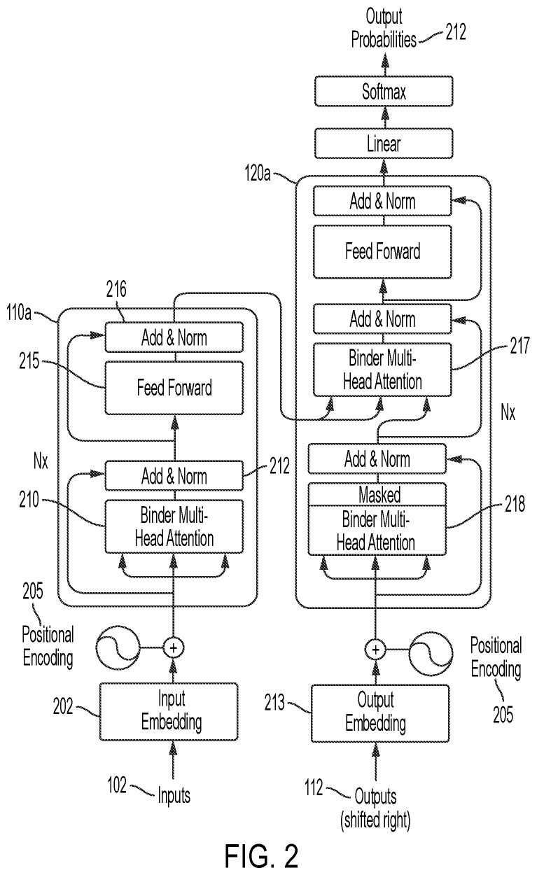

In one embodiment, each encoder layer 110a-n and/or decoder layer 120a-n may comprise one or more multi-head attention layer that computes a context vector of attention weights assigned to different parrs (e.g., tokens) of the input sequence. Additional details of the layer structure of the encoder layers 110a-n and/or the decoder layer 120a-n are described below in relation to FIG. 2.

FIG. 2 is a simplified diagram illustrating an example structure of an encoder layer 110a and/or a decoder layer 120a of the NLP model 100 shown in FIG. 1, according to some embodiments. In one embodiment, an input embedding layer may convert the input sequence of tokens or words 102 may be converted into continuous vector representations (referred to as input embeddings) that capture sematic and contextual information in the input sequence. The input embeddings 202, together with positional encoding information 205 that conveys the position of each token in the sequence, are then fed to the encoder that comprises a stack of encoder layers 110a-n.

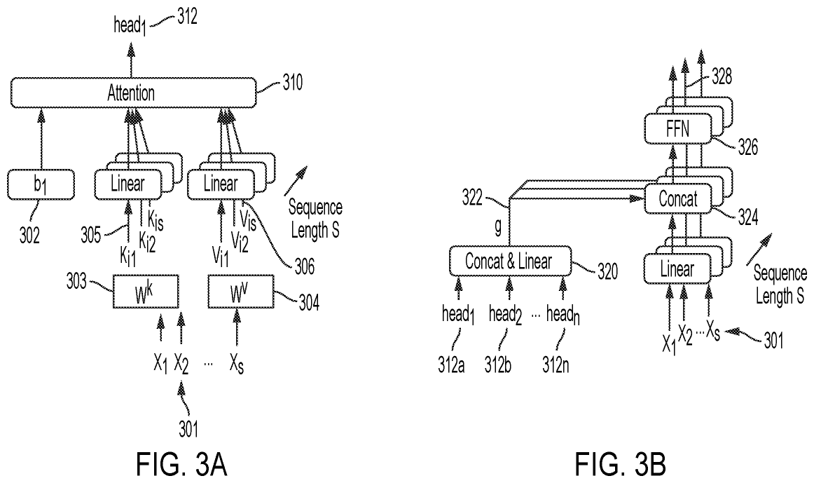

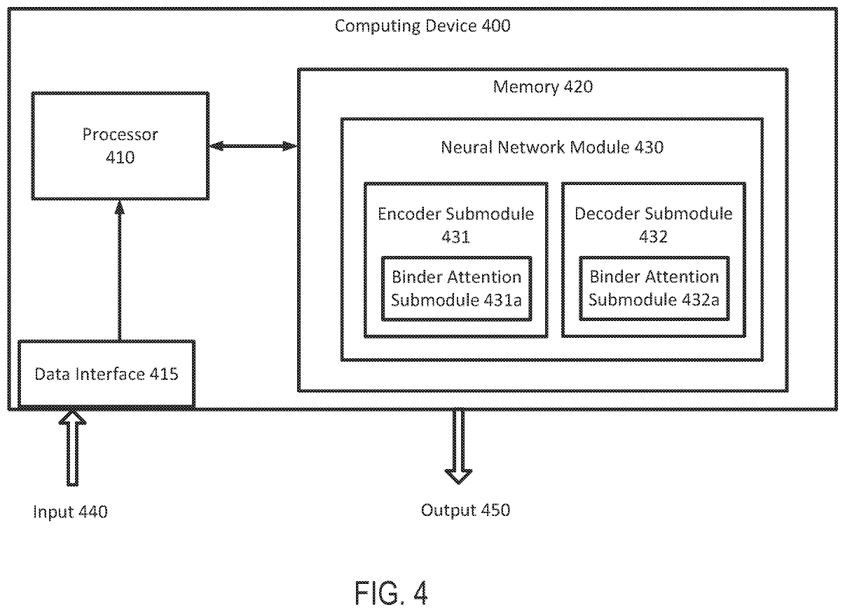

Within an encoder layer 110a, the input may be represented by xⱼ∈ [symbol] ^{d}_{model} which denotes the j^{th} feature vectors of dimension d_{model} in a sequence of length S (i.e. j∈{1, 2, . . . , S}), and x∈ [symbol] ^{S×d_model} denote the matrix containing these vectors. The binder multi-head attention layer 210 within each encoder layer 110a may comprise a plurality of attention heads placed and operated in parallel to generate a plurality of attention head outputs, e.g., as further described in relation to FIG. 3A. Attention heads within binder multi-head attention 210 of each encoder layer 110a may perform non-causal attention that attends information from both past and future positions in the input sequence simultaneously, and therefore contextual information of the whole input sequence (e.g., 102 in FIG. 1) may be captured.

In one embodiment, the plurality of attention head outputs from the binder multi-head attention module 210 may be concatenated to form a global context vector, which is then concatenated back to the feature vectors at the addition layer 212. A Feed-Forward (FFN) layer 215 is then applied to the concatenation of global context vector and the feature vectors, thus both attending to the global context vector as well as transforming the feature vectors. The output of the FFN layer 215 is then added by the addition layer 216 back to the concatenation of global context vector and the feature vectors. In one embodiment, the output of an encoder layer 110a (e.g., the (1+1)th) that includes the binder multi-head attention layer 210 and a position-wise Feed Forward layer 215, may have, at the j^{th} position,

$${x}_{j}^{l + 1} = LN ( {x}_{j}^{l} ) + LN ( FFN ( {x}_{j}^{l} ) )$$

where the superscript l denotes the layer number, and LN denotes Layer normalization. The FFN transformation is provided below for both the causal attention, and non-causal attention as described in relation to FIGS. 3A-3B.

Similarly, at the decoder of the NLP model, positional encoding 205 and output embedding 213 of previously decoded token 112 may be input to the decoder layers 120a-n. Specifically, each decoder layer 120a-n may comprise one or more binder multi-head attention modules 217, 218, followed by a FFN layer. Each binder multi-head attention modules 217, 218 may comprise a number of attention heads operated in parallel. Operations of attention heads of the binder multi-head attention layers 217, 218 of each decoder layer 120a may perform causal attention that processes an input sequence in a sequential and autoregressive manner, e.g., only information from positions preceding the current position, not future positions are considered when generating the output at a timestep. In one embodiment, masked binder multi-head attention module 218 may apply a mask to the attention weights to prevent the model from attending to positions ahead of the current position, as further described below in relation to FIG. 3B.

FIG. 3A is an example structure of at least one attention head 310 of the binder multi-head attention module 210 in FIG. 2, according to one or more embodiments described herein. At each encoding layer, given an encoder layer input of length S and encoder laying input vectors having a dimension d_{model}, for input feature vectors 301 x={x₁, . . . , xⱼ, . . . , x_{S}}, the key vector kᵢ={k_{i,1}, . . . , k_{i,j}, . . . , k_{i,S}} 305 and value vector vᵢ={v_{i,1}, . . . , v_{i,j}, . . . , v_{i,S}} 306 may be computed for each attention head:

kᵢ=xWᵢ^{K},vᵢ=xWᵢ^{v},

where Wᵢ^{K}, Wᵢ^{v}, ∈ [symbol] ^{d}^{_{model}}^{×d_head} are projection matrices 303 and 304 that transform the encoder layer input feature vector x, and i∈{1, 2, . . . , h}, where h is the number of heads. Here and below, for simplicity, the layer number l is omitted in x^{l}. Thus, no query vector is used in the attention as compared to traditional Transformer.

In one embodiment, attention head 310 may perform a non-causal attention over a binder vector 302 bᵢ ∈ [symbol] ^{d_head} for i ∈{1, 2, . . . , h}, where h is the number of heads, and the key vector 305 and value vector 306:

headᵢ=Attention(LN(bᵢ),kᵢ,vᵢ)∈ [symbol] ^{d_head},i^{th} head

where

$$Attention ( LN ( {b}_{i} ) , {k}_{i} , {v}_{i} ) = Softmax ( ( \frac{LN ( {b}_{i} ) \cdot {k}_{i}^{T}}{\sqrt{{d}_{head}}} ) {v}_{i}$$

where kᵢ=LN(xWᵢ^{K}) are the keys (e.g., generated by applying a layer normalization of key vector 305), vᵢ=L2(xWᵢ^{v}) are the values (e.g., generated by applying a L2 normalization over value vector 306); Wᵢ^{K}, Wᵢ^{V} ∈ [symbol] ^{d_model×d_head}. Therefore, the non-causal attention may be different from the traditional transformer attention that binder vectors 302 bᵢ ∈ [symbol] ^{d_head} are used in place of [symbol] ^{S×d_head} query vectors. In the binder attention head 310, the dot product between the binder vector 302 and key vectors 305 are also scale with

$$\frac{1}{\sqrt{{d}_{head}}} .$$

resulting attention output 312 corresponds to the i-th attention head 310.

In one embodiment, attention head 310 may perform a causal attention over binder vector 302 bᵢ ∈ [symbol] ^{d_head} for i ∈{1, 2, . . . , h}, where h is the number of heads, and the key vector 305 and value vector 306. Specifically, in transformers, causal attention can be implemented by applying the causal mask on the S×S attention matrix, but in the binder multi-head attention module 210, no self-attention matrix is used. The attention head output 312 is computed as:

$${head}_{ij} = \frac{{\sum }_{{j}^{′} = 1}^{j} {a}_{ij ′} {v}_{ij ′}}{{\sum }_{{j}^{′} = 1}^{j} {a}_{ij ′} + ϵ} ∈ ℝ ; softmax and multiply with value \\ {a}_{i} = exp ( LN ( {b}_{i} ) . {k}_{i} ) ∈ {ℝ}^{S} ; binder attends to keys$$

where headᵢⱼ denotes the j-th element of attention head output vector headᵢ 312; aᵢⱼ denotes the j-th element of aᵢ, and j ∈{1, 2, . . . , S}; kᵢ=LN(xWᵢ^{K}), vᵢ=L2(xWᵢ^{V}), ϵ is a small constant for numerical stability (e.g., 1e⁻⁹, etc.).

FIG. 3B is an example operation surrounding the addition and normalization layer 212, the FFN layer 215 and another addition and normalization layer 216 in FIG. 2, according to one or more embodiments described herein. In one embodiment, the binder multi-head attention module 210 may comprise a plurality of attention heads similar to attention module 310 that are operated in parallel to generate a number of attention head outputs 312a-h.

In one embodiment, for non-causal attention outputs (e.g., at an encoder layer 110a), a global context vector 322 g ∈ [symbol] ^{h×d_head} may generated at the concatenation and linear projection module 320:

$$g = concat ( {head}_{1} , {head}_{2} , … , {head}_{h} ) {W}^{0} ∈ {ℝ}^{{d}_{head}} ; global context vector$$

The resulting global context vector 322, unlike traditional transformer architectures, is not a transformed output of the input sequence x. The global context vector 322 may be concatenated back to the feature vectors at the concatenation layer 324. The position-wise FFN layer 215 that follows allows mixing between the input feature vectors 301 and the global context 322, and also computes a transformation at each position. Concretely, the position-wise FFN layer 215 computes the j^{th} position output 328 as follows,

$$FFN ( {x}_{j} ) = LN ( act ( {x}_{j}^{′} {W}_{1} + {b}_{1} ) {W}_{2} + {b}_{2} ) ∈ {ℝ}^{d \_ model} ; \\ Position - wise Feed Forward layer$$

where, x′ⱼ=concat(xⱼWₓ+bₓ, g) ∈ [symbol] ^{2d_model}; concatenate global context to input where Wₓ∈ [symbol] ^{d_model×d_model}, bₓ∈ [symbol] ^{d_model}, W₁ ∈ [symbol] ^{2d_model×d_hid}, b1 ∈ [symbol] ^{d_hid}, W₂∈ [symbol] ^{d_hid×d_model} and b₂ ∈ [symbol] ^{d_model}.

In one embodiment, combining FIGS. 3A-3B, for the non-causal attention module (e.g., 210 in FIG. 2), the total training time complexity is [symbol] (Sd²_{model}). This complexity holds for both training and inference. Specifically, for binder attention, the computation of the key and value matrices for computing headᵢ for a single attention head is [symbol] (Sd²_{model}). The attention part in Eq. 14, for all heads combined, takes [symbol] (Sd_{model}), in contrast to the transformer self-attention that is [symbol] (S²d_{model}). The complexity of concatenating the context vector g is [symbol] (d²_{model}), and concatenating the context vector g to input and FFN operation each take [symbol] (Sd²_{model}).

In one embodiment, for causal attention outputs (e.g., in a decoder layer 120a), attention head outputs headᵢⱼ may be computed using cumulative sum. For example, a recurrent network may implement the causal Binder attention. The recurrent network may maintain two states A_{i,j} and P_{i,j} for the i^{th} head and at any position j, given by,

$${A}_{i , j =} {A}_{i , j - 1} + {a}_{i , j} \\ {P}_{i , j =} {P}_{i , j - 1} + {a}_{i , j} {v}_{ij}$$

with base conditions A_{i,1}=aᵢ₁ and P_{i,1}=aᵢ₁vᵢ₁. Thus, attention head output headᵢⱼ may be computed as:

$${head}_{ij} = {P}_{i , j} / ( {A}_{i , j} + ϵ ) ∈ {ℝ}^{d \_ head} ; position - wise head$$

This speeds up inference time during autoregressive generation by making the time complexity of each token generation independent of the past sequence length. Finally, note that due to the causal nature of this computation, the context vector g is different for each position in the sequence, and is given by,

$${g}_{j} = concat ( {head}_{1 j} , {head}_{2 j} , … , {head}_{hj} ) {W}^{0} ∈ {ℝ}^{dmodel} ; \\ position - wise context vector$$

The resulting context vectors may then be concatenated back with the layer feature vectors in a similar way and passed to FFN layer 215.

In one embodiment, combining FIGS. 3A-3B, for the causal attention module, because the only difference comes from the computation of attention as compared to the non-causal attention—during training, the overall complexity is [symbol] (Sd²_{model}). However, in contrast to the non-causal attention module, the overall inference time complexity per token generation is [symbol] (d²_{model}), which is independent of the past sequence length due to the recursive nature of computation.

With reference to FIG. 2, a decoder layer 120a may employ masked binder multi-head attention 218 for language modeling and language understanding tasks, which mask certain input tokens. The masked binder multi-head attention module 218 may use a masking vector [symbol] ∈{0,1}^{S}, where 0 implies the corresponding position is ignored in the computation and 1 denotes otherwise. This vector [symbol] can be multiplied to the key matrix (e.g., collection of key vectors 305 in FIG. 3A), or equivalently to aᵢ in the causal case, along the sequence dimension to achieve the desired masking effect.

In one embodiment, traditionally, in language understanding tasks and classification tasks, a CLS token may be used, or the final layer sequence embeddings may be mean pooled to get a global embedding vector of the input sequence, which is used for computing the loss function. At decoder layer 120a, no CLS token is needed. Instead, the global context vector g from a non-causal attention layer is used for computing the loss function.

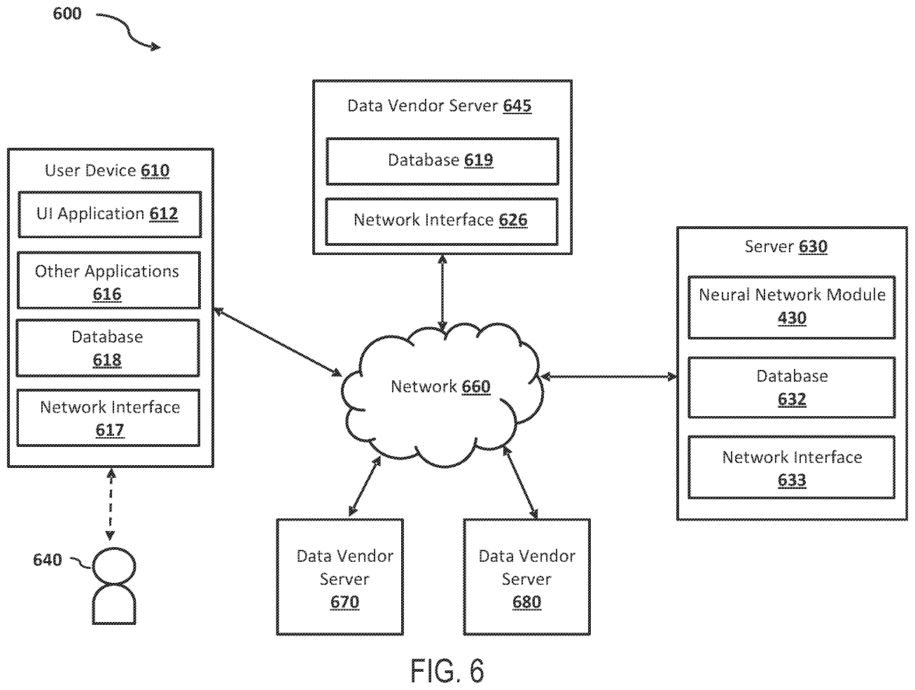

In one embodiment, the binder vectors 302 are tunable and may be updated with other model parameters of the NLP model 100 at a backpropagation during training. Additional details of training the NLP model may be discussed in relation to FIG. 5.

### Computer and Network Environment

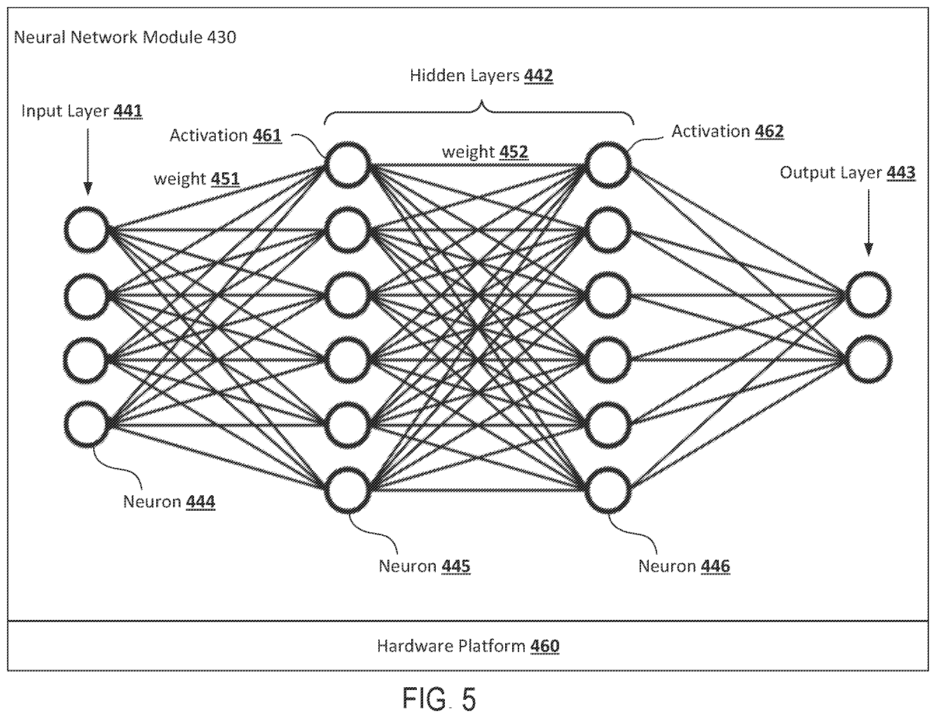

FIG. 4 is a simplified diagram illustrating a computing device implementing the binder multi-head attention described in FIGS. 1-3B, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for neural network module 430 that may be used to implement and/or emulate the systems and models, and/or to implement any of the methods described further herein. neural network module 430 may receive input 440 such as an input training data (e.g., a question, a document, a text prompt, and/or the like) via the data interface 415 and generate an output 450 which may be a NLP task output, such as an answer to an input question, a summary to an input document, and/or the like.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a question from a user via the user interface.

In some embodiments, the neural network module 430 is configured to perform an NLP task. The neural network module 430 may further include an encoder submodule 431 (e.g., similar to 110 in FIG. 1) which comprises one or more binder attention submodules 431a (e.g., similar to 210 in FIG. 2), and a decoder submodule 432 (e.g., similar to 120 in FIG. 1) which comprises one or more binder attention submodules 432a (e.g., similar to 217, 218 in FIG. 2). For example, as previously described in relation to FIGS. 3A-3B, binder attention submodule 431a in encoder submodule 431 may be configured to perform non-causal attention over a tunable binder vector and key vectors, and value vectors of an input feature vector. Binder attention submodule 432a in decoder submodule 432 may be configured to perform causal attention over a tunable binder vector and key vectors, and value vectors of an input feature vector.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the neural network module 430 described in FIG. 4, according to some embodiments. In some embodiments, the neural network module 430 and/or one or more of its submodules 431-432 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a text input. The number of nodes (neurons) in the input layer 441 may be determined by the dimensionality of the model, e.g., d_{model}. Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the neural network module 430 receives an input 440 of an input text such as a question and transforms the input into an output 450 of an answer to the question. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the neural network module 430 and/or one or more of its submodules 431-432 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be an LLM such as GPT-3, and/or the like.

In one embodiment, the neural network module 430 and its submodules 431-432 may be implemented by hardware, software and/or a combination thereof. For example, the neural network module 430 and its submodules 431-432 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based neural network module 430 and one or more of its submodules 431-432 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as a training question are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding answer to the training question) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as performing a new NLP task.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in natural language processing in a wide variety of applications, such as deploying an AI agent in customer service, education, trouble shooting, and/or the like.

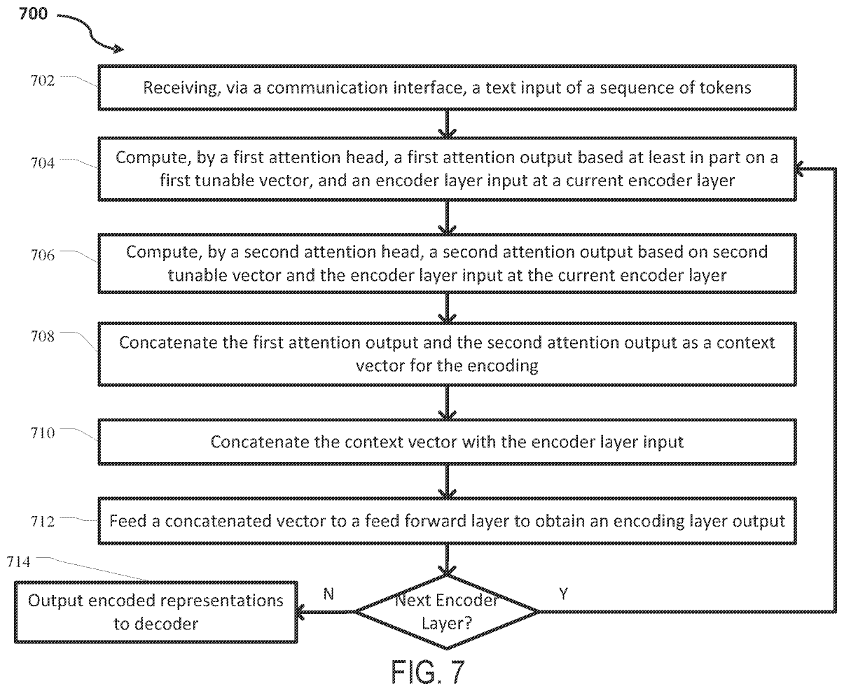

FIG. 6 is a simplified block diagram of a networked system 600 suitable for implementing the binder attention based NLP framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating an NLP task output, such as a response to a question from the server 630 and display the message via the UI application 612. In other embodiments, user device 610 may include additional or different modules having specialized hardware and/or software as required.

In one embodiment, UI application 612 may provide a conversation interface with an AI agent deployed at server 630. For example, user 640 may interactively engage in a conversation by providing a user utterance (e.g., text, audio, etc.) to the UI application 612, which in turn provide a response via the UI application 612 to conduct a conversation with user 640, e.g., for customer service, shopping assistance, education, and/or the like.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view an interactive conversation with an AI agent.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including language modeling training data to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the neural network module 430 and its submodules described in FIG. 4A. In some implementations, neural network module 430 may receive data from database 619 at the data vendor server 645 via the network 660 to generate an NLP task output. The generated NLP task output may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the neural network module 430. In one implementation, the database 632 may store previously generated task output and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

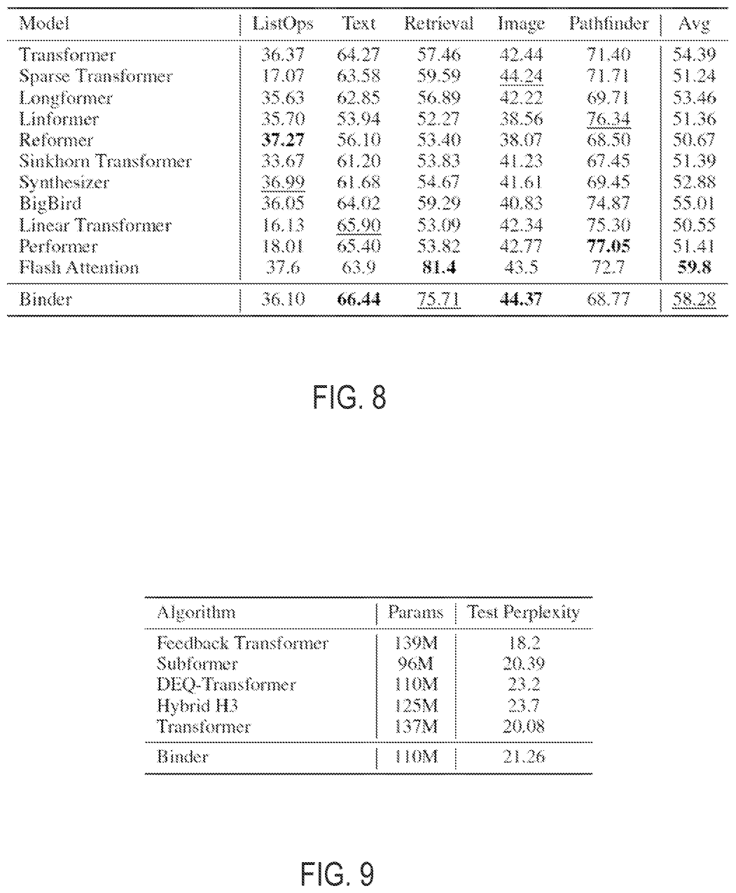

FIG. 7 is an example logic flow diagram illustrating a method of performing binder attention based natural language modeling based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the neural network module 430 (e.g., FIGS. 4 and 6) that performs binder attention based NLP.

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a text input (e.g., 102 in FIG. 1) of a sequence of tokens may be received via a communication interface (e.g., data interface 615 in FIG. 6).

At step 704, a first attention head (e.g., 310 in FIG. 3A) of an encoder (e.g., 110 in FIG. 1) of the neural network based NLP model (e.g., 100 in FIG. 1) may compute a first attention output (e.g., 312 in FIG. 3A) based at least in part on a first tunable vector (e.g., 302 in FIG. 3A) and an encoder layer input (e.g., key and value vectors 305-306 computed from the encoder layer input 301 in FIG. 3A). For example, the first attention output (e.g., 312 in FIG. 3A) is computed based on further computing a first key vector (e.g., 305 in FIG. 3A) and a first value vector (e.g., 306 in FIG. 3A) corresponding to a first feature vector corresponding to the encoder layer input (e.g., 301 in FIG. 3A). The first attention output is computed based on a softmax operation between a normalized first tunable vector (e.g., 302 in FIG. 3A), the first key vector and the first value vector, and the first key vector and the first value vector corresponds to a same first position in the sequence of input tokens.

At step 706, a second attention head may compute a second attention output based on second tunable vector and the encoder layer input.

At step 708, the first attention output (e.g., 312a in FIG. 3B) and the second attention output (e.g., 312b in FIG. 3B) may be concatenated as a context vector (e.g., 322 in FIG. 3B) for the encoding.

At step 710, the context vector (e.g., 322 in FIG. 3B) may be concatenated with the encoder layer input (e.g., 301 in FIG. 3B).

At step 712, the concatenation of the context vector and the encoder layer input may be fed to a FFN layer (e.g., 215 in FIG. 3B) to obtain an encoding layer output (e.g., 328 in FIG. 3B).

Method 700 may then decides whether the current encoding layer is the last encoding layer. If there is no next encoder layer, method 700 proceeds to step 714, at which the encoded representations (e.g., 116 in FIG. 1) from the last encoding layer may be output to the decoder (e.g., 120 in FIG. 1). For example, at the decoder layer, the third attention output is computed based attending a normalized third tunable vector and a third key vector derived from the decoder layer input, and then multiplying an attended result with a third key value derived from the decoder layer input. The third attention output is computed using cumulative sum of the attended result. At the decoder which performs causal attention, the third attention output corresponds to the third attention head and a specific position in the sequence of tokens, and the fourth attention output corresponds to the fourth attention head and the specific position in the sequence of tokens, and the context vector (e.g., gi) is position-wise and corresponds to the specific position in the sequence of tokens.

If there is a next encoder layer, method 700 may repeat from step 704 to use the encoder layer output from a previous layer as the layer input for the next encoder layer.

Specifically, the first attention output corresponds to the first attention head and a first position in the sequence of input tokens, and the second attention output corresponds to the second attention head and the first position in the sequence of tokens. The context vector (e.g., 322 in FIG. 3B) is position-wise and corresponds to the first position in the sequence of tokens.

### Example Results

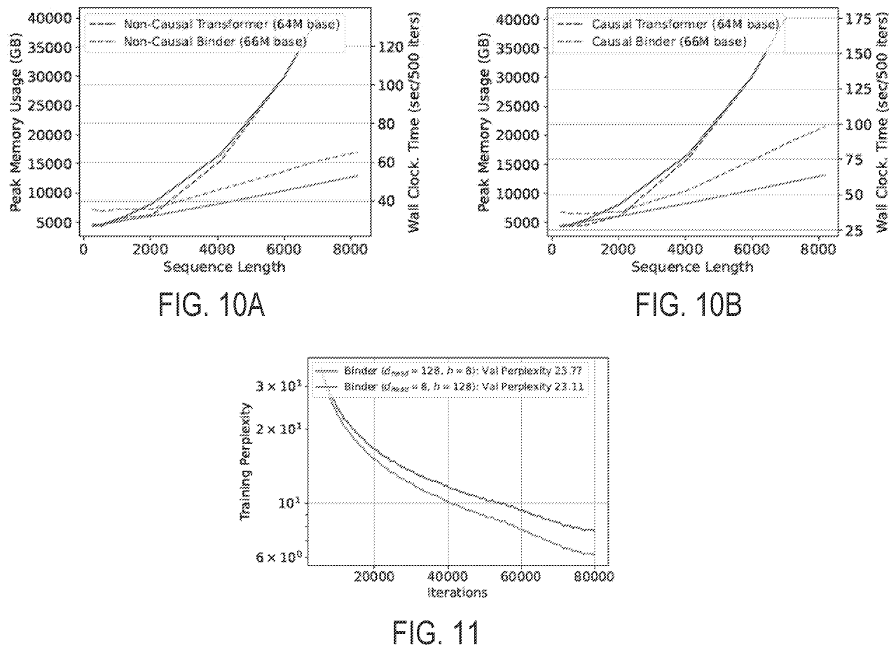

FIGS. 8-11 represent exemplary test results using embodiments described herein. In one embodiment, the binder attention based NLP model described in FIGS. 1-7 is tested on long sequence tasks, and the capacity of the model in terms of the amount of information stored is evaluated.

A number of long sequence tasks that include a mixture of language and vision tasks tasks discussed in Long Range Arena benchmark (Tay et al., Long range arena: A benchmark for efficient transformers. arXiv preprint arXiv: 2011.04006, 2020) are tested on the binder attention based NLP model described in FIGS. 1-7:

ListOps: This task is aimed at evaluating how well a model can learn to parse hierarchically structured data in a long sequence (varying between 500 and 2000). The dataset consists of a sequence of operators—MAX, MEAN, MEDIAN and SUM_MOD, along with numbers, that are scoped within brackets to specify a mathematically correct expression. The result of each such expression is an integer between 0-9. Here is a sample sequence of a short length:
INPUT: [MAX 5 7 [MIN 0 1] 2 8 [MEDIAN 1 3 5]] OUTPUT: 8

Byte-level Text Classification: This is a binary classification task on the IMDB reviews dataset. The dataset is encoded at a byte level in order to make the input sequence long and challenging. The maximum input length is 4000 for this task.

Byte-level Document Retrieval: The goal of document retrieval is to learn a similarity score between two documents, and is posed as a classification problem. Specifically, the model needs to separately extract a feature vector for two documents and these are then used to compute a similarity score between them. The ACL Anthropology Network corpus is used for this task and the sequence length for each document is 4096.

Image Classification: This task involves solving the 10 class classification problem on the CIFAR-10 dataset, where the images are transformed to gray scale, and represented with an 8-bit pixel intensity. Further the image is flattened from 32×32 to a sequence of 1024.

PathFinder: This is a synthetic image classification task involving long-range spatial dependencies. The task requires a model to classify whether two circles are connected by a path consisting of dashes. It consists of gray scale images that are flattened to a sequence of length 1024.

Performance results are shown in FIG. 8. The binder attention based NLP model is able to outperform majority of the transformer variants and scores second highest on average following Flash attention. This shows that the binder attention based NLP model described in FIGS. 1-7 perform achieves comparable performance with traditional Transformer models, while largely reduces computational complexity. Neural network technology is thus improved.

FIG. 9 shows the test perplexity on the WIkitext-103 dataset. While the LRA benchmark evaluates models on their ability to solve complex long range dependency tasks, it does not test the memorization ability of models. This is better tested by language modeling tasks.

Wikitext-103 is a standard benchmark for language modeling. It contains over a 100 million tokens extracted from Wikipedia articles. The experimental comparison on this dataset is provided in FIG. 9. The binder attention based NLP model is tested as well as the original Transformer architecture. Models of similar size and where the model is trained without any additional data are compared. This shows that the binder attention based NLP model described in FIGS. 1-7 perform achieves comparable performance with traditional Transformer-based models.

FIGS. 10A-10B show example memory usage and wall clock time performance results in the causal and non-causal setting. For example, the NLP model 100 shown in FIG. 1 may comprise an 8 layer model, with embedding size 512, 8 attention heads with each head dimensionality 64, and a vocab size of ˜50,000. The input sequence length may vary in each case in {256, 512, 1024, 2048, 4096, 6000, 7000, 8192}. During each run, the corresponding model's peak memory usage on a single GPU and the wall clock time are recorded for every 500 iterations

As shown in FIGS. 10A, the peak memory usage of the traditional Transformer architecture increases quadratically with input sequence length, while that of the Binder architecture increases linearly. Note that the data points for sequence length 8192 could not be computed for the Transformer architecture due to memory limitation of the GPU being used. In particular, binder network greatly outperforms for sequence lengths greater than 2000.

FIG. 11 shows the training perplexity vs. the number of binder heads h and the dimensionality of each head d_{head}. For example, the Wikitext-103 dataset is used to train two Binder networks with the same set of hyper-parameters, except h and d_{head}. In one case, a larger h is used, while in the other case, a larger d_{head} is used. A greater number of heads improves both optimization and generation.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for performing a natural language processing (NLP) task at a neural network based NLP model, comprising:
receiving, via a communication interface, a text input of a sequence of tokens;
encoding, by an encoder of the neural network based NLP model, the text input into one or more text representations, wherein the encoding comprises:
computing, by a first attention head, a first attention output based at least in part on a first tunable vector, and an encoder layer input,
computing, by a second attention head, a second attention output based on second tunable vector and the encoder layer input; and
concatenating the first attention output and the second attention output as a context vector for the encoding; and
generating, a decoder of the neural network based NLP model, a task output based on the one or more text representations in response to the text input.

2. The method of claim 1, wherein the first attention output is computed based on further computing a first key vector and a first value vector corresponding to a first feature vector corresponding to the encoder layer input.

3. The method of claim 2, wherein the first attention output is computed based on a softmax operation between a normalized first tunable vector, the first key vector and the first value vector,
wherein the first key vector and the first value vector corresponds to a same first position in the sequence of tokens.

4. The method of claim 1, wherein the encoding further comprises:
concatenating the context vector with the encoder layer input; and
feeding a concatenated vector to a feed forward layer to obtain an encoding layer output.

5. The method of claim 4, wherein the encoding further comprises:
computing, at a next encoding layer, a next encoding layer output using feature vectors in the encoding layer output as an input.

6. The method of claim 1, wherein generating, by the decoder of the neural network based NLP model the task output further comprising:
computing, by a third attention head, a third attention output based at least in part on a third tunable vector, and a decoder layer input,
computing, by a fourth attention head, a fourth attention output based at least I part on a fourth tunable vector, and a decoder layer input, and
concatenating the third attention output and the fourth attention output as a decoding context vector for the decoding.

7. The method of claim 6, wherein the third attention output is computed based attending a normalized third tunable vector and a third key vector derived from the decoder layer input, and then multiplying an attended result with a third key value derived from the decoder layer input.

8. The method of claim 7, wherein the third attention output is computed using cumulative sum of the attended result.

9. The method of claim 8, wherein the third attention output corresponds to the third attention head and a specific position in the sequence of tokens,
the fourth attention output corresponds to the fourth attention head and the specific position in the sequence of tokens, and
the decoding context vector is position-wise and corresponds to the specific position in the sequence of tokens.

10. The method of claim 1, further comprising:
updating the first tunable vector and the second tunable vector at a backpropagation of the neural network based NLP model during training.

11. A system for performing a natural language processing (NLP) task at a neural network based NLP model, the system comprising:
a memory that stores the neural network based NLP model and a plurality of processor executable instructions;
a communication interface that receives a text input of a sequence of tokens; and
one or more hardware processors that read and execute the plurality of processor-executable instructions from the memory to perform operations comprising:
encoding, by an encoder of the neural network based NLP model, the text input into one or more text representations, wherein the encoding comprises:
computing, by a first attention head, a first attention output based at least in part on a first tunable vector, and an encoder layer input,
computing, by a second attention head, a second attention output based on second tunable vector and the encoder layer input; and
concatenating the first attention output and the second attention output as a context vector for the encoding; and
generating, a decoder of the neural network based NLP model, a task output based on the one or more text representations in response to the text input.

12. The system of claim 11, wherein the first attention output is computed based on further computing a first key vector and a first value vector corresponding to a first feature vector corresponding to the encoder layer input.

13. The system of claim 12, wherein the first attention output is computed based on a softmax operation between a normalized first tunable vector, the first key vector and the first value vector,
wherein the first key vector and the first value vector corresponds to a same first position in the sequence of tokens.

14. The system of claim 11, wherein the encoding further comprises:
concatenating the context vector with the encoder layer input; and
feeding a concatenated vector to a feed forward layer to obtain an encoding layer output.

15. The system of claim 4, wherein the operation of encoding further comprises:
computing, at a next encoding layer, a next encoding layer output using feature vectors in the encoding layer output as an input.

16. The system of claim 11, wherein the operation of generating, by the decoder of the neural network based NLP model the task output further comprising:
computing, by a third attention head, a third attention output based at least in part on a third tunable vector, and a decoder layer input,
computing, by a fourth attention head, a fourth attention output based at least I part on a fourth tunable vector, and a decoder layer input, and
concatenating the third attention output and the fourth attention output as a decoding context vector for the decoding.

17. The system of claim 16, wherein the third attention output is computed based attending a normalized third tunable vector and a third key vector derived from the decoder layer input, and then multiplying an attended result with a third key value derived from the decoder layer input.

18. The system of claim 17, wherein the third attention output is computed using cumulative sum of the attended result.

19. The system of claim 18, wherein the third attention output corresponds to the third attention head and a specific position in the sequence of tokens,
the fourth attention output corresponds to the fourth attention head and the specific position in the sequence of tokens, and
the decoding context vector is position-wise and corresponds to the specific position in the sequence of tokens.

20. A non-transitory machine-readable medium comprising a plurality of machine-executable instructions which, when executed by one or more processors, are adapted to cause the one or more processors to perform operations comprising:
receiving, via a communication interface, a text input of a sequence of tokens;
encoding, by an encoder of the neural network based NLP model, the text input into one or more text representations, wherein the encoding comprises:
computing, by a first attention head, a first attention output based at least in part on a first tunable vector, and an encoder layer input,
computing, by a second attention head, a second attention output based on second tunable vector and the encoder layer input; and
concatenating the first attention output and the second attention output as a context vector for the encoding; and
generating, a decoder of the neural network based NLP model, a task output based on the one or more text representations in response to the text input.
